(19) United States
(12) Patent Application Publication
(10) Pub. No.: US 2014/0192666 A1
(43) Pub. Date: Jul. 10, 2014

(54) Method, apparatus and system for transmitting wireless network targeted information

(71) Applicant: Tencent Technology (Shenzhen) Company Limited, Shenzhen (CN)

(72) Inventor: Xing Zhou, Shenzhen (CN)

(21) Appl. No.: 14/146,705

(22) Filed: Jan. 2, 2014

(30) Foreign Application Priority Data
Jan. 5, 2013 (CN) 2013100020405
Nov. 8, 2013 (CN) PCT/CN2013/086808

(51) Int. Cl. H04W 8/22

(52) U.S. Cl. CPC H04W 8/22
USPC 370/252

(57) ABSTRACT

A method, apparatus and system for transmitting targeted information are provided. In the method, a type of a service which a wireless terminal is currently dealing with is identified, when it is identified that the wireless terminal is currently dealing with a data downloading service, targeted information to be transmitted currently is determined, and then the targeted information is transmitted to the wireless terminal during downloading data.

### CLAIM OF PRIORITY

The present patent application is a U.S. continuation application under 35 U.S.C. §111(a) claiming priority under 35 U.S.C. §§120 and 365(c) to International Application No. PCT/CN2013/086808 filed on Nov. 8, 2013, which claims priority of Chinese patent application No. 201310002040.5, entitled “method, apparatus and system for transmitting wireless network targeted information” and filed by applicant Tencent Technology (Shenzhen) Co., Ltd on Jan. 5, 2013, which is incorporated into the present application by reference in its entirety.

### TECHNICAL FIELD

This disclosure generally relates to information transmission techniques and more particularly, but not exclusively, to a method, apparatus and system for transmitting targeted information.

### BACKGROUND

With rapid development of wireless communication techniques and increasing popularity of wireless terminals such as smart phones, it has been made possible to transmit targeted information to a wireless terminal over a wireless network.

Currently, the targeted information is generally transmitted to the wireless terminal over the wireless network periodically or randomly. This periodical or random behavior results in a possibility that the wireless terminal is dealing with a certain service which would be better not to be disturbed, for example, a key service with a high real-time demand (such as a call service), when the targeted information is being transmitted to the wireless terminal. In this case, the targeted information transmission would contend with the key service for the limited communication resources or information processing capacity of the wireless terminal, thus causing degradation of quality of service (QoS) of the key service.

### SUMMARY

This disclosure in some aspects relates to a method, apparatus and system for transmitting targeted information over a wireless network, which is capable of preventing QoS degradation of key services associated with a wireless terminal due to transmission of targeted information to the wireless terminal.

In one aspect, a method for transmitting targeted information over a wireless network includes the following steps: identifying a type of a service which a wireless terminal is currently dealing with; determining targeted information to be transmitted currently when it is identified that the wireless terminal is currently dealing with a data downloading service; and transmitting the targeted information to the wireless terminal during downloading data.

In another aspect, an apparatus for transmitting targeted information over a wireless network includes an apparatus for transmitting targeted information, which includes an identifying module, configured to identify a type of a service which a wireless terminal is currently dealing with; a determining module, configured to determine targeted information to be transmitted currently when it is identified that wireless terminal is currently dealing with a data downloading service; and a transmitting module, configured to transmit the targeted information to the wireless terminal during downloading data.

In yet another aspect, a system for transmitting targeted information over a wireless network includes a transmitting device, configured to identify a type of a service which a wireless terminal is currently dealing with, to determine targeted information to be transmitted currently when it is identified that the wireless terminal is currently dealing with a data downloading service, and to transmit the targeted information to the wireless terminal during downloading data; and a wireless terminal, configured to receive the targeted information during downloading data, to parse the received targeted information, and to display the parsed targeted information through a display module for a download waiting page of the data.

According to the various aspects the disclosure, the type of the service which the wireless terminal is currently dealing with is identified and an opportunity for transmitting the targeted information is determined based on the identified type of the service which the wireless terminal is currently dealing with. Specifically, when it is identified that the wireless terminal is currently dealing with a data downloading service, the targeted information is transmitted to the wireless terminal during the download of the. In this way, the targeted information will not be transmitted to the wireless terminal when the wireless terminal is dealing with a key service with a high real-time demand (such as a call service), so as to avoid contending with the key service for limited communication resources or information processing capacity of the wireless terminal, which may cause degradation of quality of service (QoS) of the key service due to the transmission of the targeted information to the wireless terminal, and make rational use of the communication resources and information processing capacity of the wireless terminal.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

These and other sample aspects of the disclosure will be described in the detailed description and the claims that follow, and in the accompanying drawings, wherein:

FIG. 1 is a flowchart illustrating an example method for transmitting targeted information;

FIG. 2 is a simplified block diagram illustrating an example device for transmitting targeted information;

FIG. 3 is a simplified block diagram illustrating an example system for transmitting targeted information;

FIG. 4 is a structure schematic view illustrating the example device for transmitting targeted information; and

FIG. 5 is a structure schematic view illustrating the example system for transmitting targeted information.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The term “targeted information” used herein refers to, among others, information which is intended to be presented by an information provider to a certain group of users or audiences that may potentially be interested in such information. For example, when the information provider detects that a user is downloading a game APP from an online APP store, the information provider may deduce that the user may also be interested in other similar games, and thus presents information regarding one or more other similar games (which is referred to as “targeted information”) to the user as a recommendation.

The term “wireless terminal” used herein may take any suitable physical form. For example, it may also be referred to as a mobile device, a mobile station, a mobile phone, a user terminal, a user equipment (UE), a personal digital assistant (PDA), a tablet personal computer, a handheld device having wireless connection capability, a vehicle intelligent terminal, or any other processing devices connected to a wireless modem.

The term “data” used herein includes, but is not limited to, applications (APP), instructions, computer programs, executable computer codes, and files, such as text, audio or video files in any format.

FIG. 1 illustrates example operations for transmitting targeted information to a wireless terminal. As represented by block 101, a type of a service which the wireless terminal is dealing with is identified. As represented by block 102, targeted information to be transmitted currently is determined, when it is identified that the wireless terminal is dealing with a data downloading service. As represented by block 103, the targeted information is transmitted to the wireless terminal during downloading data.

To make rational use of information processing capacity of the wireless terminal and/or current network resources, and/or to improve targeting accuracy of the transmitted targeted information, in an example, the determining of the targeted information to be transmitted currently may include: acquiring at least one of performance information of the wireless terminal, current network resource information or content information of the data, and determining the targeted information to be transmitted currently based on the at least one of the performance information of the wireless terminal, the current network resource information or the content information of the data.

Specifically, at least one of the wireless terminal's ability or efficiency of processing multimedia information may be determined based on the performance information of the wireless terminal, and whether multimedia information is to be included in the targeted information may be determined based on at least one of the wireless terminal's ability or efficiency of processing multimedia information. For example, if it is determined that the wireless terminal is a smart terminal (i.e., the wireless terminal is able to process multimedia information, and preferably, the wireless terminal may have a relatively highly efficiency in processing multimedia information), multimedia information may be included in the targeted information; and if it is determined that the wireless terminal is a non-smart terminal and has a relatively small screen (i.e., the wireless terminal may not be able to process multimedia information, or the wireless terminal is able to process multimedia information but with a low efficiency), the multimedia information may not be included in the targeted information.

In an embodiment, the current network resource information of the wireless terminal may be used to judge whether the multimedia information transmitting rate corresponding to the current network resources meets a predetermined requirement. If yes, it may be determined to include the multimedia information in the targeted information; if no, it may be determined not to include the multimedia information in the targeted information. In an example, if the currently available network resources are sufficient, for example, the wireless terminal is currently coupled to a WIFI network of which bandwidth is enough, or if there is a fast network connection at present, for example, the wireless terminal is currently coupled to a 3G network, the multimedia information may be included in the targeted information.

In an embodiment, a storage space size to be occupied by the data may be determined based on the content information of the data, and a storage space size to be occupied by the targeted information may be determined based on the storage space size to be occupied by the data; alternatively or additionally, a content type of the data may be determined based on the content information of the data, and a content type of the targeted information may be determined based on the content type of the data. For example, the storage space size to be occupied by the targeted information may be determined such that a ratio of the storage space size to be occupied by the targeted information to the storage space size to be occupied by the data is no greater than a predetermined value. By limiting the ratio of the storage space size to be occupied by the targeted information to the storage space size to be occupied by the data, it may avoid download performance of the data from being affected by the targeted information transmission. As another example, based on the content type of the data being downloaded, targeted information associated with the content type of the data may be determined for transmission, so as to increase the targeting accuracy of the targeted information.

In an embodiment, during downloading data, the wireless terminal may receive and parse the targeted information, and display the targeted information through a display module for in the data download waiting page, such that the wireless terminal may display the targeted information without initiating any other display module, which is adapted to the characteristic of small size of the wireless terminal.

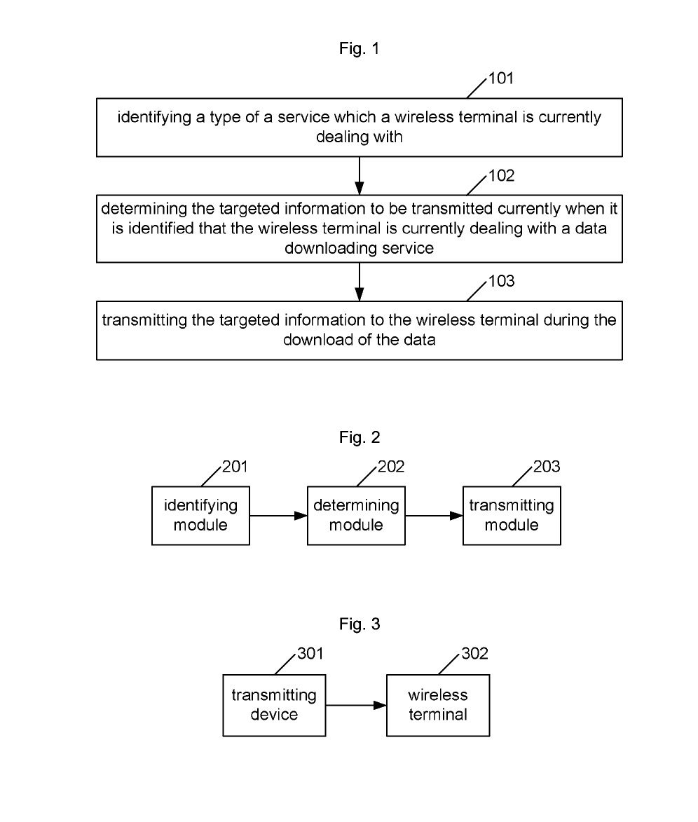

Referring to FIGS. 2 and 3, the disclosure also provides a device and system for transmitting the targeted information to implement the method described above.

FIG. 2 illustrates a simplified block diagram of a device for transmitting the targeted information according to the disclosure.

As shown in FIG. 2, the device includes an identifying module 201, a determining module 202 and a transmitting module 203.

The identifying module 201 is configured to identify a type of a service which a wireless terminal is currently dealing with.

The determining module 202 is configured to determine targeted information to be transmitted currently, when the type of the service which the wireless terminal is currently dealing with is identified as a data downloading service.

The transmitting module 203 is configured to transmit the targeted information to the wireless terminal during downloading data.

Optionally, the determining module 202 may include an acquiring unit and a targeted information determining unit.

The acquiring unit is configured to acquire at least one of performance information of the wireless terminal, current network resource information or content information of the data.

The targeted information determining unit is configured to determine the targeted information to be transmitted currently based on the at least one of the performance information of the wireless terminal, the current network resource information or the content information of the data.

Specifically, in an embodiment, the targeted information determining unit may determine whether the wireless terminal is capable of processing multimedia information or not and/or determines an efficiency of processing the multimedia information by the wireless terminal based on the performance information of the wireless terminal, and determine whether the targeted information should contain multimedia information based on whether the wireless terminal is capable of processing multimedia information or not, and/or the efficiency of processing the multimedia information by the wireless terminal. Alternatively or additionally, the targeted information determining unit may determine whether a transmission rate of the multimedia information with the current network resources meets a predetermined requirement based on the current network resource information of the wireless terminal. If yes, it may be determined to include the multimedia information in the targeted information; if no, it may be determined not to include the multimedia information in the targeted information. Alternatively or additionally, the targeted information determining unit may determine a storage space size to be occupied by the data based on the content information of the data, and determine a storage space size to be occupied by the targeted information based on the storage space size to be occupied by the data. Alternatively or additionally, the targeted information determining unit may determine a content type of the data based on the content information of the data, and determine a content type of the targeted information based on the content type of the data.

Specifically, in an embodiment, the targeted information determining unit may determine the storage space size to be occupied by the targeted information such that a ratio of the storage space size to be occupied by the targeted information to the storage space size to be occupied by the data is no greater than a predetermined value. Alternatively or additionally, the targeted information determining unit may determine targeted information associated with the content type of the data based on the content type of the data being downloaded.

As used above, the terms “module” and “unit” and the like are intended to include a computer-related entity, such as but not limited to hardware, firmware, a combination of hardware and software, software, or software in execution. For example, a module may be, but is not limited to being, a processor, a program running on a processor, and/or a computer. In addition, these modules may communicate with each other and/or communicate with other components (for example, the wireless terminal, the data provider) by way of local and/or remote processes such as in accordance with a signal from one module interacting with another module in a local system, distributed system, and/or in accordance with a signal across a network such as the Internet.

FIG. 3 illustrates the composition of the system for transmitting the targeted information according to the disclosure. As illustrated in FIG. 3, the system includes a transmitting device 301 and a wireless terminal 302.

The transmitting device 301 is configured to identify a type of a service which the wireless terminal 301 is currently dealing with, to determine targeted information to be transmitted when the wireless terminal 302 is dealing with a data downloading service, and to transmit the targeted information to the wireless terminal 302 during downloading data.

The wireless terminal 302 is configured to receive the targeted information during downloading data, to parse the received targeted information, and to display the parsed targeted information through a display module for a download waiting page of the data.

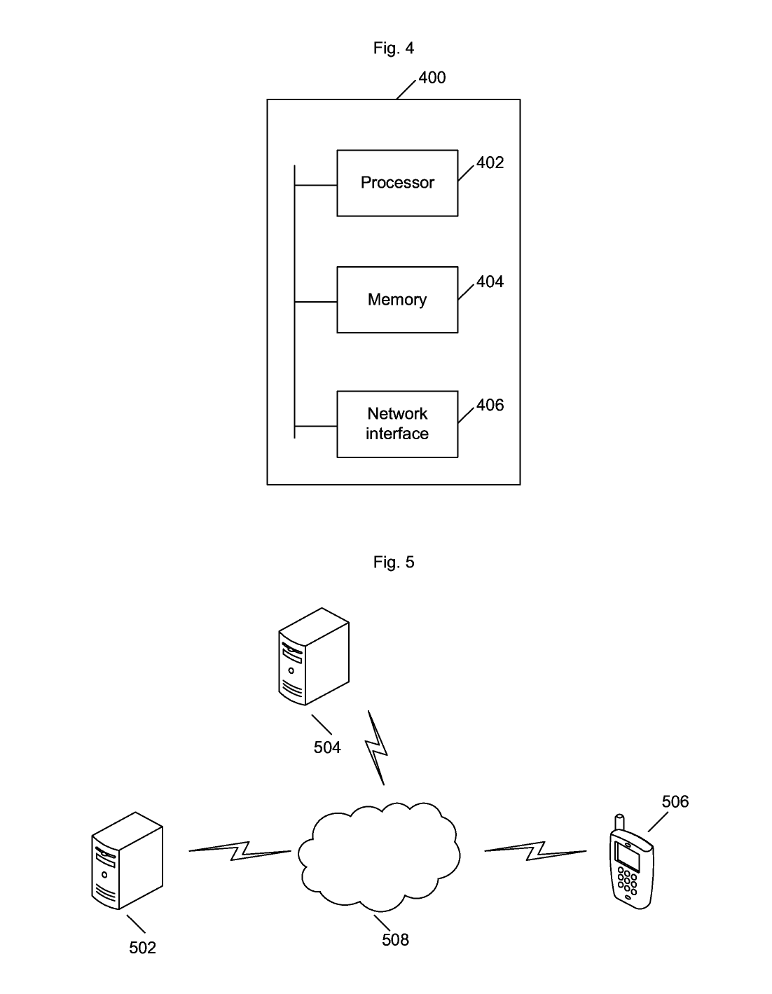

FIG. 4 is a structure schematic view illustrating a device for transmitting the targeted information as shown in FIG. 2.

Herein, the device 200 for transmitting the targeted information is implemented as a computer equipment 400. This disclosure contemplates any suitable types of computer equipments 400 for implementing the device 200. As example and not by way of limitation, the computer equipment 400 may include one or more servers. In an embodiment, software running on the one or more servers performs one or more steps of the method as described referring to FIG. 1 or implements functions of the various modules or units as described referring to FIG. 2.

In an embodiment, the computer equipment 400 may identify that a wireless terminal is downloading data, such as a game application or a movie, from a data provider, such as an APP store, a website, or a file transfer protocol (FTP) server, and determines suitable targeted information to be transmitted, such as an introduction of a similar game APP or a poster or sample slide of a recently popular movie, and the transmits the targeted information to the wireless terminal during downloading data.

In an embodiment, the computer equipment 400 includes a processor 402, a memory 404 and a network interface 406. Although this disclosure describes and illustrates a particular computer equipment having a particular number of particular components in a particular arrangement, any suitable computer equipment having any suitable number of any suitable components can be contemplated.

In an embodiment, the processor 402 includes hardware for executing instructions, for example, one or more computer programs. The processor 402 may retrieve instructions from the memory 404 and execute them. The processor 402 may be implemented as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform one or more of the method steps as described referring to FIG. 1 or to implement the various modules as described referring to FIG. 2.

In an embodiment, the memory 404 may store instructions for the processor 402 to execute or data for the processor 402 to operate on. In an embodiment, the memory 404 may include random access memory (RAM), which may be dynamic RAM (DRAM) or static RAM (SRAM) as desired. Additionally, the memory 404 may include storage for storing data and instructions, such as read-only memory (ROM), such as mask-programmed ROM, programmable ROM (PROM), erasable PROM (EPROM), electrically erasable PROM (EEPROM), electrically alterable ROM (EAROM), or flash memory. In an embodiment, the storage may be internal or external to computer equipment 400. In an embodiment, the storage stores instructions for performing one or more of the method steps as described referring to FIG. 1 or for implementing the various modules as described referring to FIG. 2. The data being downloaded by the wireless terminal may also be located in this storage, or may be located in a storage locally connected to this storage, or may be located in a storage remote to this storage. As an example and not by way limitation, the computer equipment 400 may load instructions from the storage or other sources (for example, remote sources) to the RAM, and then the processor 402 may retrieve the instructions from the RAM to execute them. In an embodiment, the memory 404 may include one or more memories.

In an embodiment, the network interface 406 enables the computer equipment 400 to access a network (for example, a personal area network (PAN), a local area network (LAN), a wide area network (WAN), a WIFI network, a mobile communication network, etc.) for communication with one or more other devices, for example, the data provider and the wireless terminal.

Herein, one or more computer readable storage media may be contemplated for implementing any suitable storage. In an embodiment, a computer readable storage medium may implement at least some portions of the memory 404. For example, the computer readable storage medium may include both ROM and RAM. The computer readable storage medium may be implemented as a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or any other suitable computer-readable storage medium.

FIG. 5 illustrates a structure schematic view of a system for implementing transmission of the targeted information. As shown in FIG. 5, the system includes a transmitting device 502, a data provider 504 and a wireless terminal 506, which may be connected to each other through a network 508.

In an embodiment, the transmitting device 502 may be implemented as the computer equipment 400 as described referring to FIG. 4, and thus the detailed description of the structure thereof is omitted here. The transmitting device 502 identifies a type of a service which the wireless terminal 506 is currently dealing with, determines targeted information to be transmitted when identifying the wireless terminal 506 is dealing with a data downloading service, for example, downloading data from a data provider 504, and then transmits the targeted information to the wireless terminal 506 during downloading data.

In an embodiment, the wireless terminal 506 has, among other things, instructions, for example, computer programs stored therein. When the instructions are executed by the wireless terminal 506, the wireless terminal 506 may implement operations of receiving the targeted information from the transmitting device 502, parsing the received targeted information, and displaying the parsed targeted information. The targeted information may be inserted in a download waiting page of the data for display. For example, the targeted information may be presented in a predefined area of the download waiting page. Alternatively, the targeted information may be presented as a floating window, either fixed or movable, over the download waiting page of the data.

While the foregoing disclosure discusses illustrative aspects and/or embodiments, it should be noted that various changes and modifications could be made herein without departing from the scope of the described aspects and/or embodiments as defined by the appended claims.

1. A method for transmitting targeted information, comprising:
identifying a type of a service which a wireless terminal is currently dealing with;
determining targeted information to be transmitted currently when it is identified that the wireless terminal is currently dealing with a data downloading service; and
transmitting the targeted information to the wireless terminal during downloading data.

2. The method according to claim 1, wherein the determining the targeted information to be transmitted currently comprises:
acquiring at least one of performance information of the wireless terminal, current network resource information or content information of the data; and
determining the targeted information to be transmitted currently based on the at least one of the performance information of the wireless terminal, the current network resource information or the content information of the data.

3. The method according to claim 2, wherein the determining the targeted information to be transmitted currently based on the at least one of the performance information of the wireless terminal, the current network resource information or the content information of the data comprises at least one of the following:
determining at least one of the wireless terminal's ability or efficiency of processing multimedia information based on the performance information of the wireless terminal, and determining whether the multimedia information is to be included in the targeted information based on the at least one of the wireless terminal's ability or efficiency of processing the multimedia information;
judging whether a multimedia information transmitting rate corresponding to current network resources meets a predetermined requirement based on the current network resource information of the wireless terminal, if yes, determining to include the multimedia information in the targeted information; if no, determining not to include the multimedia information in the targeted information;
determining a storage space size to be occupied by the data based on the content information of the data, and determining a storage space size to be occupied by the targeted information based on the storage space size to be occupied by the data; or
determining a content type of the data based on the content information of the data, and determining a content type of the targeted information based on the content type of the data.

4. The method according to claim 2, the determining the targeted information to be transmitted currently based on the at least one of the performance information of the wireless terminal, the current network resource information or the content information of the data comprises at least one of the following:
determining at least one of the wireless terminal's ability or efficiency of processing the multimedia information based on the performance information of the wireless terminal, and determining whether multimedia information is to be included in the targeted information based on at least one of the wireless terminal's ability or efficiency of processing the multimedia information;
judging whether a multimedia information transmitting rate corresponding to current network resources meets a predetermined requirement based on the current network resource information of the wireless terminal, if yes, determining to include the multimedia information in the targeted information; if no, determining not to include the multimedia information in the targeted information;
determining a storage space size to be occupied by the data based on the content information of the data, and determining the storage space size to be occupied by the targeted information such that a ratio of the storage space size to be occupied by the targeted information to the storage space size to be occupied by the data is no greater than a predetermined ratio; or
determining a content type of the data based on the content information of the data, and determining the targeted information associated with the content type of the data based on the content type of the data.

5. The method according to claim 1, further comprising the following performed by the wireless terminal during downloading data:
receiving the targeted information;
parsing the received targeted information; and
displaying the parsed targeted information through a display module for a download waiting page of the data.

6. An apparatus for transmitting targeted information, comprising:
an identifying module, configured to identify a type of a service which a wireless terminal is currently dealing with;
a determining module, configured to determine targeted information to be transmitted currently when it is identified that wireless terminal is currently dealing with a data downloading service; and
a transmitting module, configured to transmit the targeted information to the wireless terminal during downloading data.

7. The apparatus according to claim 6, wherein the determining module comprises:
an acquiring unit, configured to acquire at least one of performance information of the wireless terminal, current network resource information or content information of the data; and
a targeted information determining unit, configured to determine the targeted information to be transmitted currently based on the at least one of the performance information of the wireless terminal, the current network resource information or the content information of the data.

8. The apparatus according to claim 6, wherein the targeted information determining unit is configured to perform at least one of the following:
determine at least one of the wireless terminal's ability or efficiency of processing multimedia information based on the performance information of the wireless terminal, and determine whether the multimedia information is to be included in the targeted information based on the at least one of the wireless terminal's ability or efficiency of processing the multimedia information;
determine whether a multimedia information transmitting rate corresponding to current network resources meets a predetermined requirement based on the current network resource information of the wireless terminal, if yes, determine to include the multimedia information in the targeted information; if no, determine not to include the multimedia information in the targeted information;
determine a storage space size to be occupied by the data based on the content information of the data, and determine a storage space size to be occupied by the targeted information based on the storage space size to be occupied by the data; or
determine a content type of the data based on the content information of the data, and determine a content type of the targeted information based on the content type of the data.

9. The apparatus according to claim 8, wherein the targeted information determining unit is configured to perform at least one of the following:
determine the storage space size to be occupied by the targeted information such that a ratio of the storage space size to be occupied by the targeted information to the storage space size to be occupied by the data is no greater than a predetermined ratio, or determine the targeted information associated with the content type of the data based on the content type of the data.

10. A system for transmitting targeted information, comprising:
a transmitting device, configured to identify a type of a service which a wireless terminal is currently dealing with, to determine targeted information to be transmitted currently when it is identified that the wireless terminal is currently dealing with a data downloading service, and to transmit the targeted information to the wireless terminal during downloading data; and
a wireless terminal, configured to receive the targeted information during downloading data, to parse the received targeted information, and to display the parsed targeted information through a display module for a download waiting page of the data.

11. A device, comprising:
a processor; and
a memory, coupled to the processor, and comprising instructions that, when executed, cause the processor to:
identify a type of a service which a wireless terminal is currently dealing with;
determine targeted information to be transmitted currently when it is identified that the wireless terminal is currently dealing with a data downloading service; and
transmit the targeted information to the wireless terminal during downloading data.

12. The device according to claim 11, wherein the instructions that, when executed, cause the processor to determine the targeted information to be transmitted currently comprises instructions that, when executed, cause the processor to:
acquire at least one of performance information of the wireless terminal, current network resource information or content information of the data; and
determine the targeted information to be transmitted currently based on the at least one of the performance information of the wireless terminal, the current network resource information or the content information of the data.

13. The device according to claim 12, wherein the instructions that, when executed, cause the processor to determine the targeted information to be transmitted currently based on the at least one of the performance information of the wireless terminal, the current network resource information or the content information of the data comprises at the least one of the following instructions that, when executed, cause the processor to:
determine at least one of the wireless terminal's ability or efficiency of processing the multimedia information based on the performance information of the wireless terminal, and determine whether multimedia information is to be included in the targeted information based on the at least one of the wireless terminal's ability or efficiency of processing the multimedia information;
judge whether a multimedia information transmitting rate corresponding to current network resources meets a predetermined requirement based on the current network resource information of the wireless terminal, if yes, determine to include the multimedia information in the targeted information; if no, determine not to include the multimedia information in the targeted information;
determine a storage space size to be occupied by the data based on the content information of the data, and determine a storage space size to be occupied by the targeted information based on the storage space size to be occupied by the data; or
determine a content type of the data based on the content information of the data, and determine a content type of the targeted information based on the content type of the data.

14. The device according to claim 12, wherein the instructions that, when executed, cause the processor to determine the targeted information to be transmitted currently based on the at least one of the performance information of the wireless terminal, the current network resource information or the content information of the data comprises at least one of the following instructions that, when executed, cause the processor to:
determine at least one of the wireless terminal's ability or efficiency of processing the multimedia information based on the performance information of the wireless terminal, and determining whether multimedia information is to be included in the targeted information based on at least one of the wireless terminal's ability or efficiency of processing the multimedia information;
judge whether a multimedia information transmitting rate corresponding to current network resources meets a predetermined requirement based on the current network resource information of the wireless terminal, if yes, determine to include the multimedia information in the targeted information; if no, determine not to include the multimedia information in the targeted information;
determine a storage space size to be occupied by the data based on the content information of the data, and determining the storage space size to be occupied by the targeted information such that a ratio of the storage space size to be occupied by the targeted information to the storage space size to be occupied by the data is no greater than a predetermined ratio; or
determine a content type of the data based on the content information of the data, and determining the targeted information associated with the content type of the data based on the content type of the data.

15. A non-transitory computer-readable storage medium including a first set of instructions that, when executed, cause one or more processors to:
identify a type of a service which a wireless terminal is currently dealing with;
determine targeted information to be transmitted currently when it is identified that the wireless terminal is currently dealing with a data downloading service; and
transmit the targeted information to the wireless terminal during downloading data.

16. The non-transitory computer-readable storage medium according to claim 15, wherein the instructions that, when executed, cause the one or more processors to determine the targeted information to be transmitted currently comprises instructions that, when executed, cause the one or more processors to:
acquire at least one of performance information of the wireless terminal, current network resource information or content information of the data; and
determine the targeted information to be transmitted currently based on the at least one of the performance information of the wireless terminal, the current network resource information or the content information of the data.

17. The non-transitory computer-readable storage medium according to claim 16, wherein the instructions that, when executed, cause the one or more processors to determine the targeted information to be transmitted currently based on the at least one of the performance information of the wireless terminal, the current network resource information or the content information of the data comprises at the least one of the following instructions that, when executed, cause the one or more processors to:
determine at least one of the wireless terminal's ability or efficiency of processing multimedia information based on the performance information of the wireless terminal, and determine whether the multimedia information is to be included in the targeted information based on the at least one of the wireless terminal's ability or efficiency of processing the multimedia information;
judge whether a multimedia information transmitting rate corresponding to current network resources meets a predetermined requirement based on the current network resource information of the wireless terminal, if yes, determine to include the multimedia information in the targeted information; if no, determine not to include the multimedia information in the targeted information;
determine a storage space size to be occupied by the data based on the content information of the data, and determine a storage space size to be occupied by the targeted information based on the storage space size to be occupied by the data; or
determine a content type of the data based on the content information of the data, and determine a content type of the targeted information based on the content type of the data.

18. The non-transitory computer-readable storage medium according to claim 16, wherein the instructions that, when executed, cause the one or more processors to determine the targeted information to be transmitted currently based on the at least one of the performance information of the wireless terminal, the current network resource information or the content information of the data comprises at least one of the following instructions that, when executed, cause the one or more processors to:
determine at least one of the wireless terminal's ability or efficiency of processing the multimedia information based on the performance information of the wireless terminal, and determining whether multimedia information is to be included in the targeted information based on at least one of the wireless terminal's ability or efficiency of processing the multimedia information;
judge whether a multimedia information transmitting rate corresponding to current network resources meets a predetermined requirement based on the current network resource information of the wireless terminal, if yes, determine to include the multimedia information in the targeted information; if no, determine not to include the multimedia information in the targeted information;
determine a storage space size to be occupied by the data based on the content information of the data, and determining the storage space size to be occupied by the targeted information such that a ratio of the storage space size to be occupied by the targeted information to the storage space size to be occupied by the data is no greater than a predetermined ratio; or
determine a content type of the data based on the content information of the data, and determining the targeted information associated with the content type of the data based on the content type of the data.

19. The non-transitory computer-readable storage medium according to claim 16, further comprising a second set of instructions that, when executed, cause the one or more processors to:
receive the targeted information;
parse the received targeted information; and
display the parsed targeted information through a display module for a download waiting page of the data.
